(19) United States
(12) Patent Application Publication
(10) Pub. No.: US 2007/0286039 A1
(43) Pub. Date: Dec. 13, 2007

(54) Tracking controlling apparatus, method and program

(75) Inventor: Kazuya Isono, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/802,456

(22) Filed: May 23, 2007

(30) Foreign Application Priority Data
Jun. 7, 2006 (JP) 2006-158580

(51) Int. Cl. G11B 7/00

(52) U.S. Cl. 369/44.29; 369/44.27

(57) ABSTRACT

An off-track state is to be detected accurately. A photodetector 11 converts the light reflected from an optical disc into an electrical signal. A MIRR signal generating circuit 16 generates a bi-level MIRR signal 23, indicating whether the photodetector 11 is in an on-track state or an off-track state with respect to a track of the optical disc, based on an output signal of the photodetector 11. A TEC signal generating circuit 17 generates a bi-level TEC signal 24, indicating whether the photodetector 11 is on an inner side or on an outer side in the radial direction of the optical disc with respect to the track in the optical disc currently closest to the photodetector, based on the output signal of the photodetector 11. An off-track detector 18 outputs an off-track signal 25 if, after the level of the MIRR signal 23 is changed from an on-track state to an off-track state, the level of the TEC signal 24 is changed without the level of the MIRR signal 23 being changed.

### RELATED APPLICATIONS

The present application is based on a Japanese Patent Application No. 2006-158580 filed on Jun. 07, 2006 claiming the priority thereof under Paris Convention, the entire disclosure thereof being herein incorporated by reference thereto.

### FIELD OF THE INVENTION

This invention relates to a tracking controlling apparatus, method and program and, in particular, to a technique of track position setting control in an optical disc.

### BACKGROUND OF THE INVENTION

If, in an optical disc device, carrying spirally or circumferentially extending recording tracks, it is desired to speedily access a preset one of the tracks, it is customary to access the track by track jump, in which an optical pickup (optical head) is moved along the radius of the optical disc, and to count the number of traversed tracks, that is, the number of times of traversing neighboring concave and convex surfaces that make up the tracks.

FIG. 8 depicts a block diagram showing the position relationships between photodetectors of an optical pickup and an optical disc surface. In the optical pickup, four sensors A to D are routinely arranged in a matrix configuration. From an output (A+B+C+D) of the four sensors at the time of track jump, a mirror signal (MIRR signal), assuming a peak value at the center of the convex surface of the disc, is detected. Also, from the difference of the sensor output (A+B) and (C+D), a tracking error signal, assuming a peak value at the boundary between the concave and convex surfaces of the disc, is detected. During reproduction, recording data formed in the concave surface (signal surface) of the preset track is read out as sensor output (A+B+C+D) which is an RF signal.

When the optical pickup is positioned above the concave surface of the optical disc, reflected light volumes of both sensor outputs (A+B) and (C+D) are small, so that the tracking error signal (TE signal), corresponding to the difference of the two sensor outputs, is approximately zero. When the optical pickup is positioned above the convex surface of the optical disc, the TE signal, corresponding to the signal difference, is approximately zero, because of large signal volume of both of the two sensor outputs. In the boundary region of the convex and concave surfaces, a difference between the sensor outputs (A+B) and (C+D) is produced. The TE signal assumes a peak value at a position of a maximum difference value. A sensor output (A+B+C+D) has a minimum light reflection volume on the concave surface where the recording information is recorded. On the convex surface, where the amount of light reflection is maximal, the MIRR signal assumes a peak value.

FIG. 9 is a schematic view showing the relationship between various physical positions of the optical pickup relative to the optical disc surface and respective signals. When the position of the optical pickup is changed, the amounts of reflected light received by the four sensors A to D are varied, so that the TE and MIRR signals, as control signals, are varied. In FIG. 9, the position of the optical pickup is in a boundary region of the convex and concave surfaces. The information signal on the distance the optical pickup is moved, or on the speed of movement of the optical pickup, at the time of track jump, in a servo system for CD, CD-ROM or DVD, is obtained from the TEC signal or the MIRR signal, each being a pulse resulting from shaping of the TE signal.

FIG. 10 depicts a block diagram showing a typical circuit for generating signals used for track position control in the optical disc. In FIG. 10, an RF signal generating circuit 103 outputs an RF signal 112 based on the relative intensities of the light reflected back to a photodetector 101 from the track. A MIRR signal generating circuit 104 receives the RF signal 112 and compares the envelope of the signal level of the RF signal 112 to an MIRR decision level to output an MIRR signal 113 representing a mirror area between data tracks. On the other hand, a tracking error generating circuit 102 outputs a difference signal between output signals corresponding to light intensities on the left and right sides from the photodetector 101. The difference signal represents the deviation of the light beam from the track center. A TEC signal generating circuit 105 receives the tracking error signal 111 and compares it to a reference voltage level of the tracking error signal 111 to output binary coded tracking error zero-crossing signals, that is, a TEC signal 114 representing track crossing. The number of track count pulses, derived from the number of the binary coded signals, is counted to calculate the number of tracks traversed by the optical pickup.

In reading out recorded data in an optical disc, the optical pickup needs to be positioned on a track. If positioning is not feasible, owing to extraneous factors, such as vibrations or impacts to the disc system from outside, data readout is discontinued, so that, in case of music reproduction, for example, the reproduction signal is interrupted. At this time, the MIRR signal, indicating the pickup position on the optical disc, indicates that the optical pickup is moving back and forth i.e., oscillating, between neighboring tracks. Since an optical medium is read out contact-free, it is weak against extraneous factors, such as vibrations. It is therefore critical to cause the disc system to quickly return to the state of reproduction to improve the performance. In the known manner, the MIRR signal is checked to determine that the optical pickup has ceased to be positioned on the track during music reproduction. Or, the tracking error signal level is checked for confirming that servo control has ceased to be exercised as regularly.

FIG. 11 depicts a graph for illustrating the routine method for confirming the off-track state by the track error TE signal. Specifically, FIG. 11 shows an off-track signal for a case where, in detecting an off-track state, the number of times the tracking error amplitude detection signal has exceeded a threshold value is defined to be four. In this case, a tracking error is detected when the optical pickup has been moved from a non-off-track state to around a second neighboring track.

FIG. 12 depicts a graph for illustrating a routine method for confirming the off-track state by the MIRR signal. Specifically, FIG. 12 shows an off-track signal for a case where, in detecting an off-track state, the number of times the MIRR signal has been generated is defined to be two. In this case, a tracking error is detected when the optical pickup has been moved from the off-track state to around the second neighboring track.

The case where an off-track state has occurred and the optical pickup position has been shifted appreciably may be detected as described above.

As a related technique, Patent Document 1 discloses an off-track detection circuit in which an accurate off-track detection signal (MIRR signal) may be generated even if the modulation degree achieved is not sufficient as when the optical pickup is in a non-recorded region in a CD-R/CD-RW. This off-track detection circuit detects an envelope signal of a reflected light volume signal and cuts off a DC component of the envelope signal. The resulting signal is compared to a preset level to output the result of comparison as an off-track detection signal. Based on this off-track detection signal, the off-track detection circuit detects the off-track direction subsequent to track search to quickly supply a braking signal for the tracking servo.

### [Patent Document 1]

Japanese Patent Kokai Publication No. JP-P2001-43539A

### SUMMARY OF THE DISCLOSURE

The following analyses are given by the present invention. The entire disclosure of the above Patent Document is herein incorporated by reference thereto.

If, in detecting the off-track state based only on the TE signal, as in the related art described above, the light beam position is fluctuated in the vicinity of a threshold value for tracking error amplitude detection, an off-track signal is produced even though no off-track state actually persists. In such case, the result is erroneous detection. For example, if the photodetector is moved between an off-track position, such as a position (2) or (4), and a non-track-off position, such as a position (1), (3) or (5), as shown in FIGS. 13A and 13B, it may occur that amplitude of the TE signal exceeds the threshold value of tracking error amplitude detection. It is noted that position figures shown encircled in the drawing depict the positions (N). In such case, the tracking error amplitude detection signal is repeatedly changed between 0 and 1. Hence, an off-track signal is generated even in cases where the state may not definitely be taken as an off-track state, in terms of practical tracking control, irrespective of how accurately the MIRR signal has been extracted. For example, if the off-track signal is generated in case tracking error amplitude detection indicates ‘1’ four times, as in the case of FIG. 11, an off-track signal would be generated at a position (8). Meanwhile, detection of ‘1’ four times is only by way of illustration and the number of times of detection may be set to any suitable value greater than 1. It is naturally possible to reduce the sensitivity (provability) of erroneously detecting the off-track condition despite the fact the off-track state suspected is on the verge of occurring but is actually not generated. However, the detection time until an off-track state would actually occur would be protracted in such case.

On the other hand, if, in detecting the off-track state based only on the MIRR signal, as conventionally, the light beam position is fluctuated in the vicinity of the threshold value of detection of the mirror signal, an off-track signal is generated even though the off-track state does not persist. The result in such case is erroneous detection. For example, if a photodetector is moved (oscillated) between an off-track position (e.g. the position (2) or (4)) and a non-off-track position (e.g. the position (1), (3) or (5)), as shown in FIGS. 14A and 14B, the MIRR signal is repeatedly changed between 0 and 1. Thus, an off-track signal persists even though the state may not be said to be off-track in terms of practical tracking control. If an off-track signal is generated when the MIRR signal has become ‘1’ twice, as in FIG. 12, the off-track signal would be generated at the position (4). Meanwhile, as in the above-described case for the TE signal, detection of ‘1’ twice is only by way of illustration and the number of times of detection may be set to any suitable larger value. It is then possible to reduce the provability of erroneously deciding that the off-track condition has occurred despite the fact the off-track state suspected is on the verge of occurring but actually is not produced. However, the detection time would be protracted in case the off-track state has actually occurred in such case.

The present inventor has found that, if off-track conditions are detected using only the tracking error signal or the mirror signal, the probability is high that, even though the optical pickup is operating with the off-signal detection signal in the vicinity of an off-track threshold value, an erroneous decision be given that an off-track state have occurred, thus lowering the reliability of the off-signal detection signal. That is, in the conventional off-track detection method, an off-track state may erroneously be detected notwithstanding the fact that no off-track state has occurred. This erroneous detection may be brought about due to noise superposed on the tracking error signal, disturbances in the track, or to the detection signal being in the vicinity of a threshold value, with the tracking state not being an off-track state. The present inventor has found that this erroneous detection is ascribable to giving the decision on the off-track state based on only the tracking error signal or the mirror signal and, based on this finding, has arrived at the concept of the present invention.

In a first aspect of the present invention, there is provided a tracking controlling apparatus comprising a photodetector, a MIRR signal generator, a TEC (track error control) signal generator, and an off-track detector. The photodetector converts light reflected back from an optical disc into an electrical signal. The MIRR signal generator generates a MIRR signal representing, by a bi-level signal, whether the reflected light corresponds to a concave part or a convex part in the optical disc, based on an output signal of the photodetector. The TEC signal generator generates a TEC signal, representing, by a bi-level signal, whether the photodetector is positioned on an inner side or on an outer side in the radial direction of the optical disc with respect to a track (currently) closest to the photodetector, based on an output signal of the photodetector. The off-track detector detects an off-track state by detecting that, in case the level of the MIRR signal indicates that the reflected light corresponds to the convex part, the level of the TEC signal is changed without change in the level of the MIRR signal.

In a second aspect of the present invention, there is provided a tracking controlling method using a tracking controlling apparatus including a photodetector, a MIRR signal generator, and a TEC signal generator. The photodetector converts the light reflected back from an optical disc into an electrical signal. The MIRR signal generator generates a MIRR signal representing, by a bi-level signal, whether the reflected light corresponds to a concave part or a convex part in the optical disc, based on an output signal of the photodetector. The TEC signal generator generates a TEC signal, representing, by a bi-level signal, whether the photodetector is positioned on an inner side or on an outer side in the radial direction of the optical disc with respect to a track (currently) closest to the photodetector, based on an output signal of the photodetector. If, as the level of the MIRR signal indicates that the reflected light corresponds to the convex part, the level of the TEC signal is changed, without change in the level of the MIRR signal, this is determined to be an off-track state.

In a third aspect of the present invention, there is provided a program run on a computer making up a tracking controlling apparatus including a photodetector, a MIRR signal generator, and a TEC signal generator. The photodetector converts the light reflected back from an optical disc into an electrical signal. The MIRR signal generator generates a MIRR signal representing, by a bi-level signal, whether the reflected light corresponds to a concave part or a convex part in the optical disc, based on an output signal of the photodetector. The TEC signal generator generates a TEC signal, representing, by a bi-level signal, whether the photodetector is positioned on an inner side or on an outer side in the radial direction of the optical disc with respect to a track (currently) closest to the photodetector, based on an output signal of the photodetector. The program allows the computer to perform the processing of outputting an off-track signal if, in case the level of the MIRR signal indicates that the reflected light corresponds to the convex part, the level of the TEC signal is changed without change in the level of the MIRR signal.

The meritorious effects of the present invention are summarized as follows.

According to the present invention, in which the transition states are observed based on the TEC and MIRR signals in combination, the photodetector positions on the tracks may be detected accurately without being affected by the noise or disturbances generated on transitions from one state to the next. Hence, the off-track state may accurately be detected even in case the optical pickup movements are changed due to extraneous factors such as impacts or vibrations.

### BRIEF DESCRIPTION OF THE DRAWINGS

FIG. 1 is a block diagram showing the constitution of a tracking controlling apparatus for carrying out the present invention.

FIG. 2 is a schematic view showing the relationship between the recording surface of an optical disc and signal waveforms of various parts of the tracking controlling apparatus.

FIGS. 3A and 3B are diagrammatic views showing the relationship between signal changes of the MIRR and TEC signals, photodetector positions and figures denoting the states.

FIG. 4 is a schematic view showing state transitions in the off-track detector.

FIG. 5 is a schematic view showing signal waveforms of various parts in the tracking controlling apparatus in case the photodetector is being shifted towards an (radially) outer side of the optical disc.

FIG. 6 is a schematic view showing signal waveforms of various parts in the tracking controlling apparatus in case the photodetector is being shifted towards an inner side of the optical disc.

FIGS. 7A and 7B are schematic views similar to FIG. 5 and showing signal waveforms of various parts in the tracking controlling apparatus in case the photodetector is being shifted towards an outer side of the optical disc.

FIG. 8 is a schematic view showing the position relationship between the light receiving section of the optical pickup and the optical disc surface.

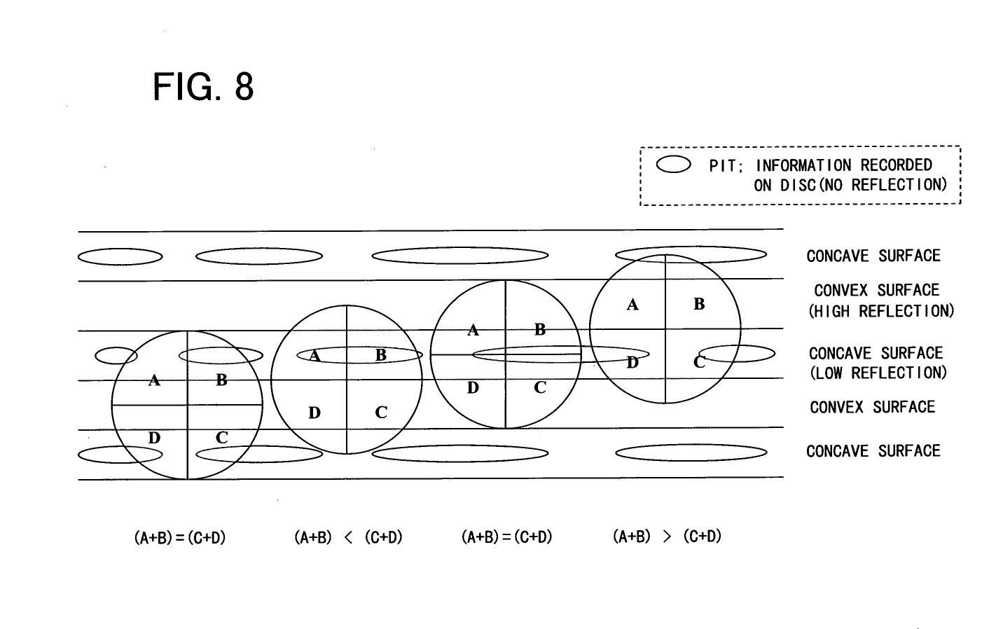

FIG. 9 is a schematic view showing the relationship between the physical positions of the optical pickup relative to the optical disc surface and the various signals.

FIG. 10 is a block diagram showing an example of a circuit for generating a signal used for track positioning control in an optical disc,

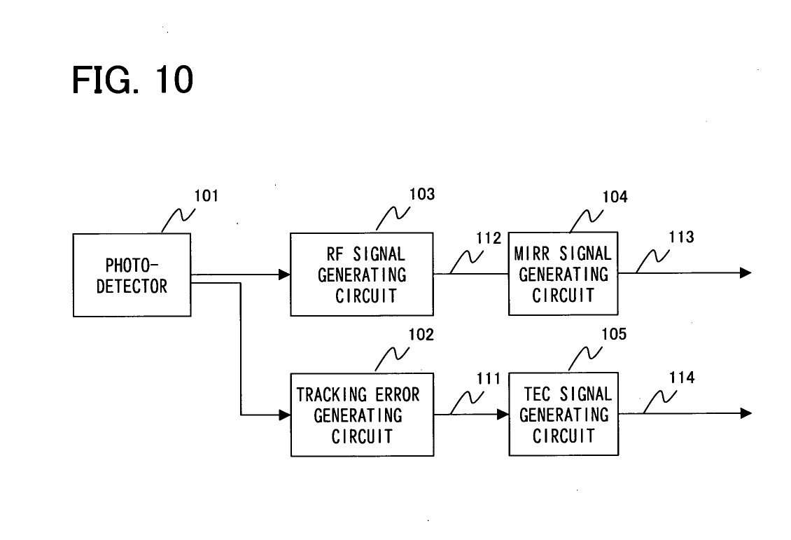

FIG. 11 is a schematic view for illustrating a routine method for confirming an off-track state by a TE signal.

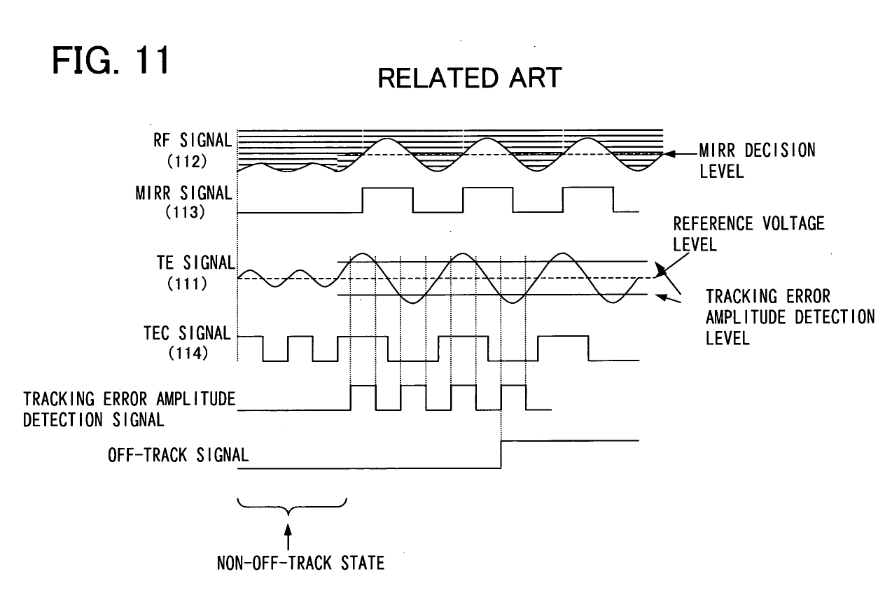

FIG. 12 is a schematic view for illustrating a routine method for confirming an off-track state by a MIRR signal.

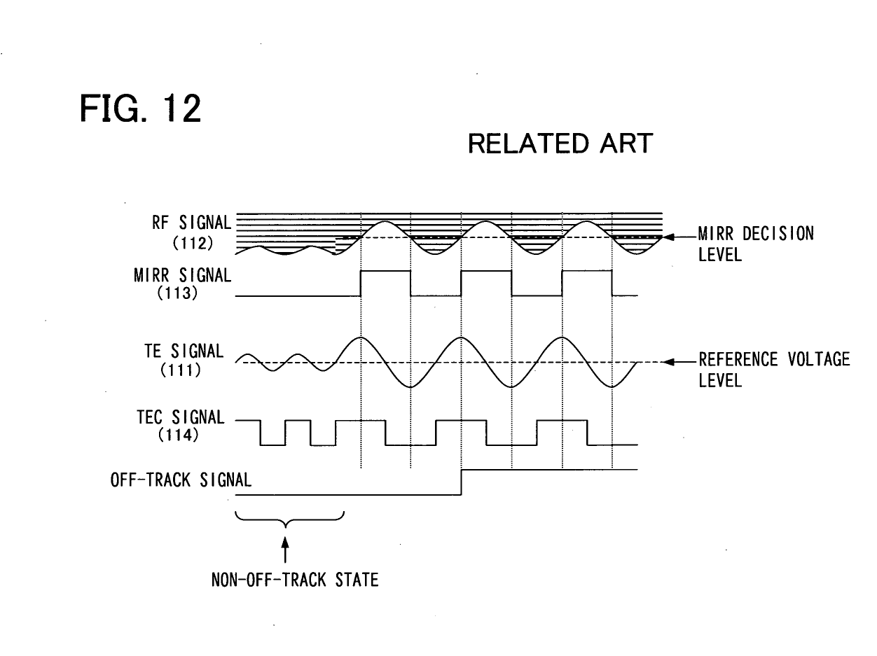

FIGS. 13A and 13B are schematic views for illustrating a routine case where an off-track state has been erroneously detected by the routine method using the TE signal.

FIGS. 14A and 14B are schematic views for illustrating a case where an off-track state has been erroneously detected by the routine method using the MIRR signal.

### PREFERRED MODES OF THE INVENTION

The MIRR signal may indicate that, when the reflected light corresponds to the concave part, the MIRR signal is in an on-track state with respect to the track of the optical disc, and that, when the reflected light corresponds to the convex part, the MIRR signal is in an off-track state with respect to the track; and the off-track detector may output an off-track signal if the level of the MIRR signal has changed from an on-track state to an off-track state and thereafter the level of the TEC signal has changed without change in the level of the MIRR signal.

The off-track detector may exercise state transition control over states comprising:

a first state in which the level of the MIRR signal indicates an on-track state;

a second state to which the first state transitions if, in the first state, the TEC signal is in a second level and the level of the MIRR signal indicates an off-track state;

a third state to which the second state transitions if, in the second state, the TEC signal has changed to a first level;

a fourth state to which the first state transitions if, in the first state, the TEC signal is in the first level and the level of the MIRR signal represents an off-track state; and

a fifth state to which the fourth state transitions if, in the fourth state, the TEC signal has changed to the second level;

the off-track detector outputting an off-track signal when state transition is to the third state or to the fifth state.

The off-track signal may indicate that, upon state transition to the third state, the photodetector has shifted from the on-track position in the first state in one radial direction of the optical disc; the off-track signal indicating that, upon state transition to the fifth state, the photodetector has shifted from the on-track position in the first state in the other radial direction of the optical disc.

The off-track detector may exercise state transition control so that

if, in the third state, the level of the MIRR signal indicates an on-track state, the state transitions from a state in which the photodetector is at the track in the first state to a state in which the photodetector is moved to a neighboring track along one radial direction of the optical disc;

if, in the third state, the TEC signal has changed to the second level, the state transitions to the second state;

if, in the fifth state, the level of the MIRR signal indicates an on-track state, the state transitions from a state in which the photodetector is at the track in the first state to a state in which the photodetector is moved to a neighboring track along the other radial direction of the optical disc; and

if, in the fifth state, the TEC signal has changed to the first level, the state transitions to the fourth state.

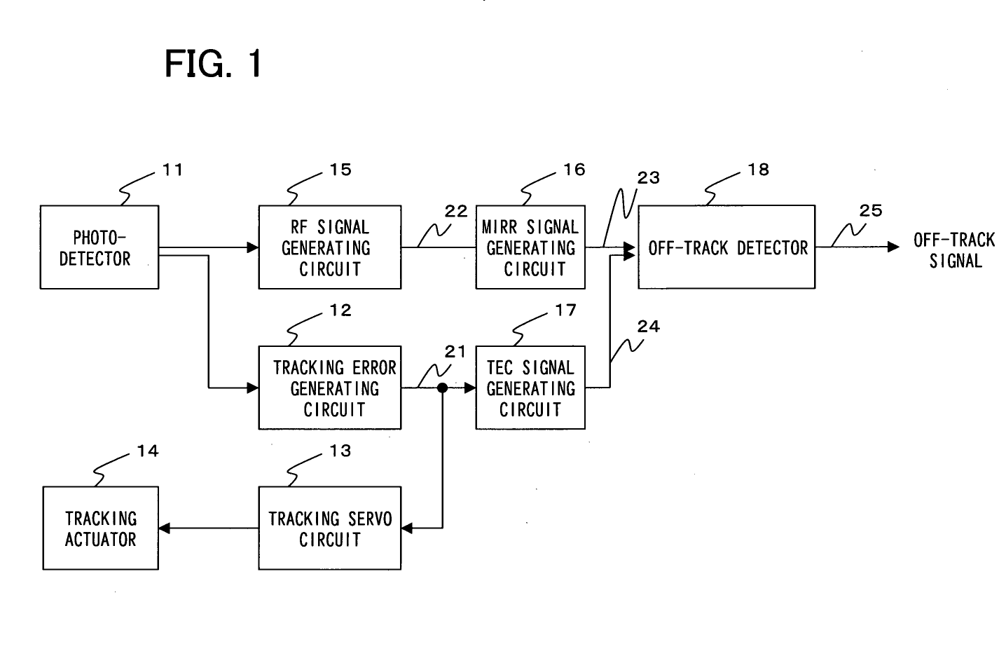

The tracking controlling apparatus according to a mode of the present invention includes a photodetector (11 of FIG. 1), a MIRR signal generator (15, 16 of FIG. 1), a TEC signal generator (12, 17 of FIG. 1), and an off-track detector (18 of FIG. 1). The photodetector converts the light reflected back from an optical disc into an electrical signal. The MIRR signal generator generates a MIRR signal representing, by a bi-level signal, whether the reflected light corresponds to a concave part or a convex part in the optical disc, based on an output signal of the photodetector. The TEC signal generator generates a TEC signal based on an output signal of the photodetector. The TEC signal has a first level indicating that the photodetector is positioned on an inner side in the radial direction of the optical disc with respect to a track (currently) closest to the photodetector, and a second level indicating that the photodetector is positioned on its outer side.

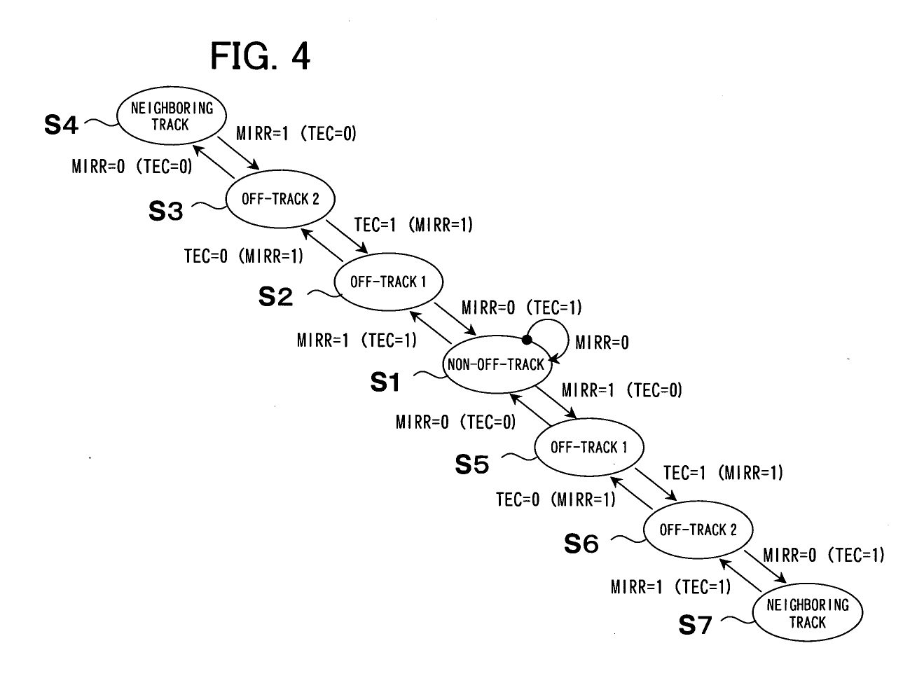

The off-track detector outputs an off-track signal (25 of FIG. 1) if, after the level of the MIRR signal has changed from the on-track state to the off-track state, the level of the TEC signal is changed without the level of the MIRR signal being changed. In more detail, the off-track detector exercises status transition control over a first state (S1 of FIG. 4), a second state (S2 of FIG. 4), a third state (S3 of FIG. 4), a fourth state (S5 of FIG. 4) and a fifth state (S6 of FIG. 4). In the first state, the level of the MIRR signal indicates an on-track state. The second state is a state to which the first state transitions if, in the first state, the TEC signal is in a second level and the level of the MIRR signal indicates an off-track state. The third state is a state to which the second state transitions if, in the second state, the TEC signal has changed to a first level. The fourth state is a state to which the first state transitions if, in the first state, the TEC signal is in the first level and the level of the MIRR signal represents an off-track state. The fifth state is a state to which the fourth state transitions if, in the fourth state, the TEC signal has changed to the second level. The off-track detector outputs an off-track signal when state transition is to the third state or to the fifth state. The off-track signal indicates that, when state transition is to the third state, the photodetector has shifted to off-track from the on-track position in the first state in one radial direction of the optical disc, while indicating that, when the state transition is to the fifth state, the photodetector has shifted to off-track from the on-track position in the first state in the other radial direction of the optical disc. The off-track detector may be implemented by having a computer of the tracking controlling apparatus run a program designed for exercising the status transition control.

The off-track detector exercises state transition control so that, if, in the third state, the level of the MIRR signal indicates an on-track state, state transition is from the state in which the photodetector is at the track in the first state to a state in which the photodetector is moved to a radially outer neighboring track (S4 of FIG. 4), and so that, if the TEC signal has changed to the second level, state transition is to the second state. The off-track detector also exercises state transition control so that, if, in the fifth state, the level of the MIRR signal indicates an on-track state, state transition is from the state in which the photodetector is at the track in the first state to a state in which the photodetector is moved to a radially inner neighboring track (S7 of FIG. 4), and so that, if, in the firth state, the TEC signal has changed to the first level, state transition is to the fourth state.

The above-described tracking controlling apparatus detects movements of the photodetector based on changes both in the TEC and MIRR signals. One of the signals remains stabilized, at a change point of the other signal, which is susceptible to the noise, so that it becomes possible to prevent erroneous detection of the off-track state. On the other hand, measurement of the off-track signals to capture the number of track crossings and the speed of state transitions allows for estimation of the degree of off-track states. Preferred examples of the present invention will now be described with reference to the drawings.

### FIRST EXAMPLE

FIG. 1 is a block diagram showing the constitution of a tracking control apparatus examplifying the present invention. In FIG. 1, a tracking controlling apparatus includes a photodetector 11, a tracking error generating circuit 12, a tracking servo circuit 13, a tracking actuator 14, an RF signal generating circuit 15, a MIRR signal generating circuit 16, a TEC signal generating circuit 17 and an off-track detector 18.

When a light beam is irradiated from an optical pickup to a number of recording tracks, arranged spirally or concentrically on a disc, that is, an optical information recording medium, the reflected light exhibits differential light intensities on the left and right sides (transverse) of the track direction. These differential light intensities are captured by at least four photodetector segments of the photodetector 11 which are separated in the left and right directions.

The tracking error generating circuit 12 outputs a difference signal as an output signal, corresponding to light intensities of left and right beams of the photodetector 11, that is, a tracking error signal 21 representing positional deviation of the light beam with respect to (from) the track center. The tracking servo circuit 13 receives the tracking error signal 21 and actuates the tracking actuator 14, such as to reduce the position deviation between the light beam and the track, based on the tracking error signal 21, to correct the light beam position. This tracking servo loop allows the light beam to follow track position variations highly accurately such as to suppress the position deviation between the light beam spot and the track, that is, the tracking error, to a smaller value.

The RF signal generating circuit 15 outputs an RF signal 22, based on the relative intensities of the light from the photodetector 11 reflected back from the track. The MIRR signal generating circuit 16 receives the RF signal 22 and compares an envelope of the signal level of the RF signal 22 to a MIRR decision level to output a MIRR signal 23 indicating a mirror region between neighboring data tracks. The MIRR signal 23 indicates, by a bi-level signal, whether the photodetector 11 is in an on-track state or 0-state, indicated by a low level, or in an off-track state or 1-state, indicated by a high level.

The TEC signal generating circuit 17 receives the tracking error signal 21 and detects a reference voltage level of the tracking error signal 21 to output a TEC signal 24 indicating traversing (crossing) a track. The TEC signal 24 has a first level or 0 level (low level), indicating that the photodetector 11 is on an inner side of the closest track of the optical disc, and a second level or 1-level (high-level), indicating that the photodetector 11 is on an outer side of the closest track.

The off-track detector 18 receives the MIRR signal 23 and the TEC signal 24 and exercises status transition control responsive to changes in the MIRR signal 23 and the TEC signal 24, as later described, to detect the movement (displacement) of the photodetector 11. When the status transition has reached a preset state, an off-track signal 25 is output.

The off-track signal 25 denotes the off-track state as well as the off-track direction in which the off-track has occurred. In addition, the amount (distance) of tracking deviation may be comprehended (obtained) by counting the off-track signals 25. Thus, the processing for restoring the photodetector to the on-track position may be carried out quickly by using the off-track signal 25. That is, the off-track state, brought about due to disturbances in the tracking error signal or to unusual servo operations, caused e.g. by interferences, such as vibrations, or by dropout of disc signals, may be corrected quickly.

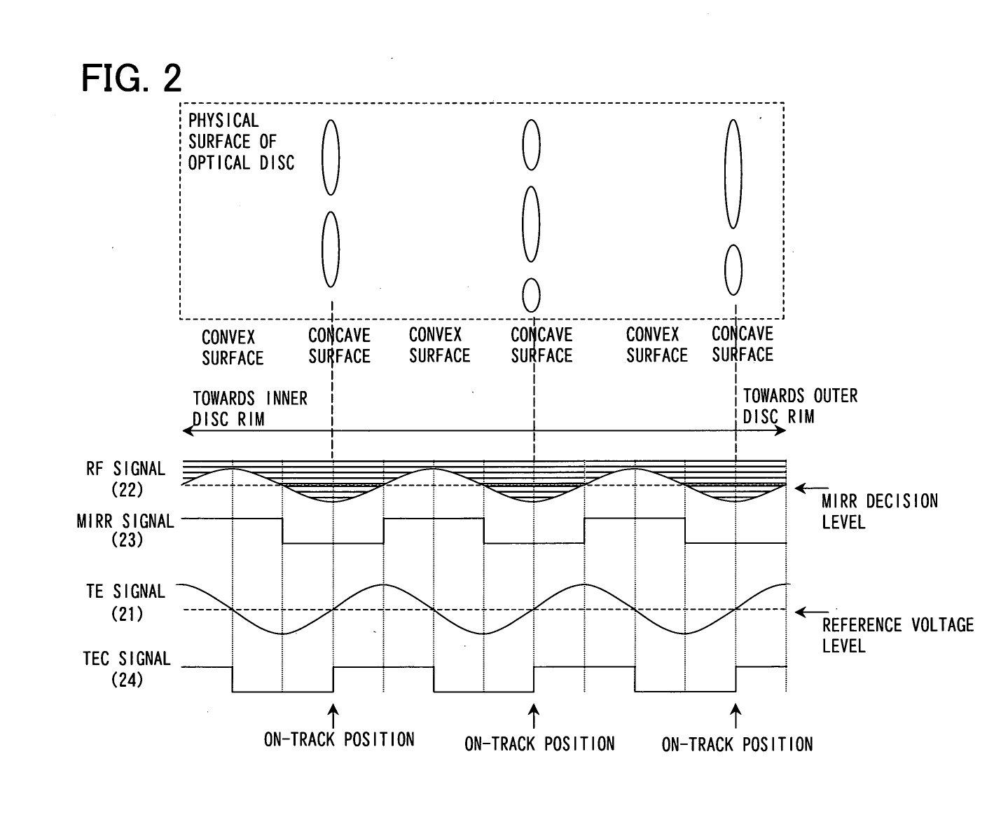

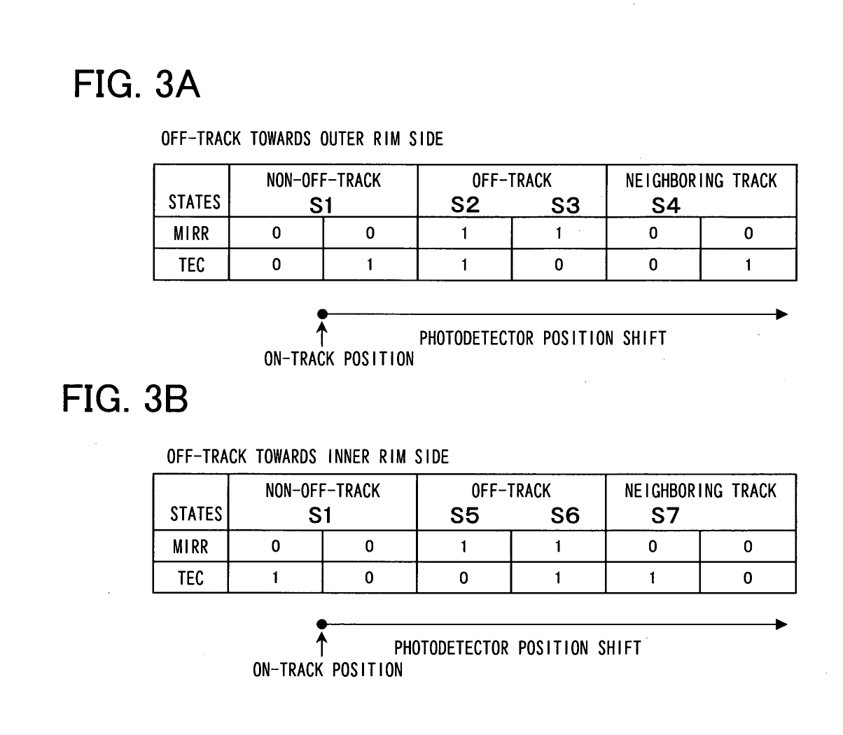

FIG. 2 schematically shows the relationship between the recording surface on the optical disc and signal waveforms at various portions in the tracking controlling apparatus. In FIG. 2, it is assumed that, in case the photodetector 11 has moved (displaced) from an on-track position towards the outside of the optical disc, the signal waveform of each signal proceeds rightwards in FIG. 2. It is also assumed that, in case the photodetector 11 has moved from an on-track position towards the inside of the optical disc, the signal waveform of each signal proceeds leftwards in FIG. 2. The signal changes, in this case, of the MIRR signal 23, and TEC signal 24 are as shown in FIGS. 3A and 3B.

FIGS. 3A and 3B show the relationship between signal changes of the MIRR signal 23 and the TEC signal 24, the positions of the photodetector 11, and the numbers indicating the states. In a non-off-track state S1, the MIRR signal 23 is ‘0’, indicating an on-track state. If now an off-track state has occurred, the MIRR signal 23 is ‘1’, indicating the off-track state. The direction of the off-track may be discerned based on the level of the TEC signal 24 at this time. Referring to FIG. 3A, in case the photodetector is off-track towards the outer side of the track, as shown in FIG. 3A, the MIRR signal 23 initially becomes ‘1’, with the TEC signal 24 being ‘1’ (state S2). The TEC signal 24 then becomes ‘0’ (state S3). The MIRR signal 23 then becomes ‘0’, and the photodetector moves to an outer neighboring track (state S4). Referring to FIG. 3B, in case the photodetector is off-track on the inner side of the track, as shown in FIG. 3B, the MIRR signal 23 initially becomes ‘1’, with the TEC signal 24 being ‘0’ (state S5). The TEC signal 24 then becomes ‘1’ (state 6). The MIRR signal 23 then becomes ‘0’, with the photodetector moving to an inner neighboring track (state S7).

The signal changes in case where an off-track state has occurred but an on-track state is restored without the photodetector moving to the neighboring track, will now be described. In case the photodetector is moved off-track outwards, the MIRR signal 23 initially becomes ‘1’, with the TEC signal 24 being ‘1’ (state S2). If the photodetector 11 is moved further outwards, the TEC signal 24 becomes zero ‘0’ (state S3). If the photodetector reverts to the non-off-track state, under control by the tracking servo circuit 13, the MIRR signal 23 becomes zero ‘0’ (state S1). In this manner, the changes of the TEC signal 24 and the MIRR signal 23 are uniquely (unequivocally) determined in accordance with (or in response to) the movement of the photodetector 11.

FIG. 4 is a schematic view for illustrating state transition in the off-track detector. Referring to FIG. 4, the off-track detector 18 detects the following seven states S1 to S7. The state S1 is a non-off-track state. The state S2 is an off-track 1 state, in which the photodetector 11 is on the verge of moving outwards away from an inherent path (orbit) of a track to be followed. The state S3 is an off-track 2 state, in which the photodetector 11 has moved to a position closer to the outer neighboring track. The state S4 is a state in which the photodetector 11 has moved to the outer neighboring track. The state S5 is an off-track 1 state, in which the photodetector 11 is on the verge of moving inwards away from the inherent path (orbit) of the track to be followed. The state S6 is an off-track 2 state, in which the photodetector 11 has moved to a position closer to the inner neighboring track. The state S7 is a state in which the photodetector 11 has moved to the inner neighboring track. Between any of the above states, transition from track to track occurs using the MIRR signal 23 and the TEC signal 24. The off-track detector 18 supervises status transitions between these states to detect the off-track states of the photodetector as well as the off-track directions thereof.

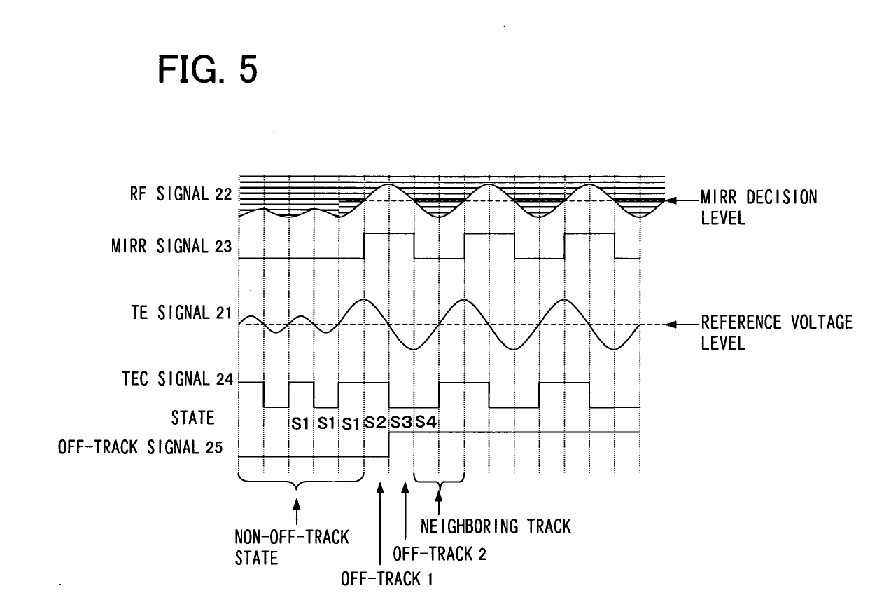

FIG. 5 shows signal waveforms at various points in the tracking controlling apparatus in case the photodetector is shifted towards the outer side of the optical disc. In FIG. 5, an off-track signal 25 is output on transition from the state S2 to the state S3 in FIG. 4. If the photodetector is not off-track, the MIRR signal 23 is ‘0’, so that the state is the non-off-track state S1. At a position where the photodetector is off-track, the MIRR signal 23 becomes ‘1’ when initially the TEC signal 24 is ‘1’. So, the photodetector moves to the off-track 1 state S2. If the TEC signal 24 becomes ‘0’ from this off-track 1 state S2, the photodetector moves to the off-track 2 state S3. The off-track signal 25 changes to ‘1’ at this timing.

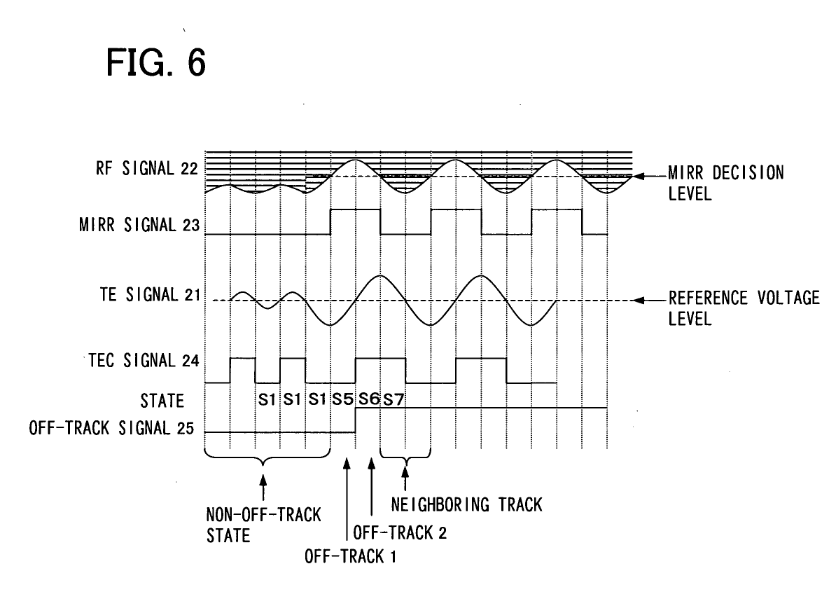

FIG. 6 shows signal waveforms of various points (nodes) of the tracking controlling apparatus in case the photodetector is shifted towards the inner side of the optical disc. In FIG. 6, an off-track signal 25 is output on transition from the state S5 to the state S6 in FIG. 4. If the photodetector is not off-track initially, the MIRR signal 23 is ‘0’, so that the state is the non-off-track state S1. At a position where the photodetector is off-track, the MIRR signal 23 becomes ‘1’ when initially the TEC signal 24 is ‘0’. Thus, the photodetector moves to the off-track 1 state S5. If the TEC signal 24 becomes ‘1’ from this off-track 1 state S5, the photodetector moves to the off-track 2 state S6. The off-track signal 25 becomes ‘1’ at this timing.

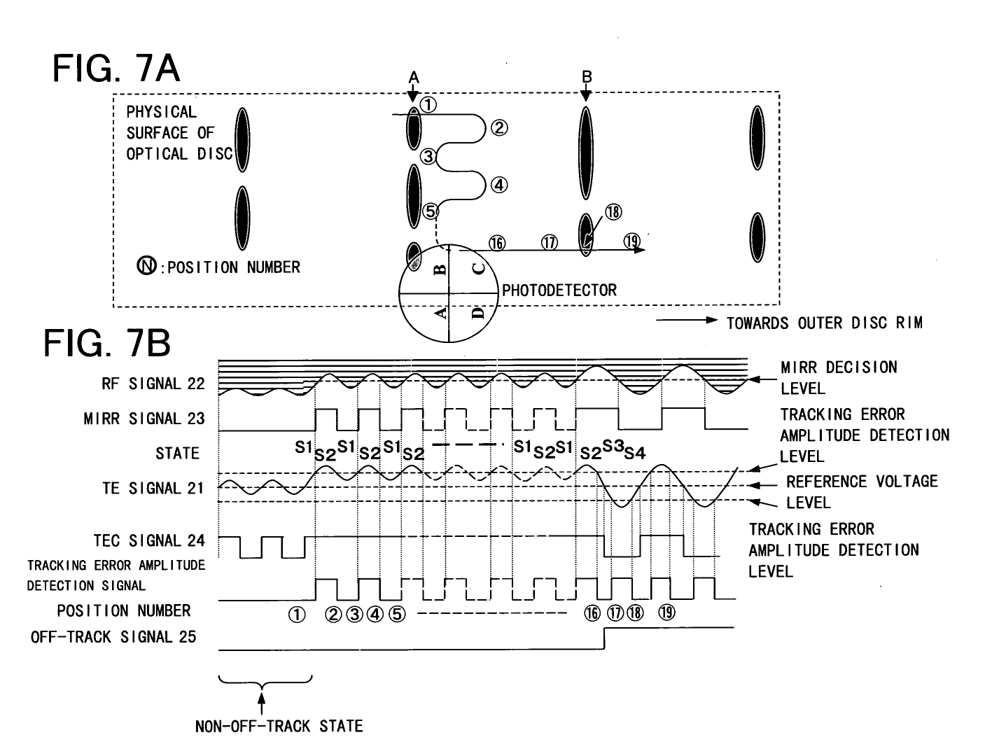

FIGS. 7A and 7B show signal waveforms of various points of the tracking controlling apparatus in case the photodetector is shifted in a direction towards outside of the optical disc. Specifically, FIGS. 7A and 7B show a case where the photodetector is wobbling between a non-off-track position (the position (1), (3), (5), . . . ) and a state in which the photodetector is on the verge of an off-track state (the position (2), (4), . . . ), as shown in FIG. 7A. That is, the photodetector is initially moved through the positions (1), (2), (3), (4), (5), and subsequently moved to the positions (16), (17), (18), (19). More specifically, the photodetector repeats transitions between the state S1 (the position (1), (3), (5), . . . ) and the state S2 (the position (2), (4), . . . ), after which the photodetector shifts to the state S2 at the position (16), to the state S3 at the position (17) and to the state S4 at the position (18)

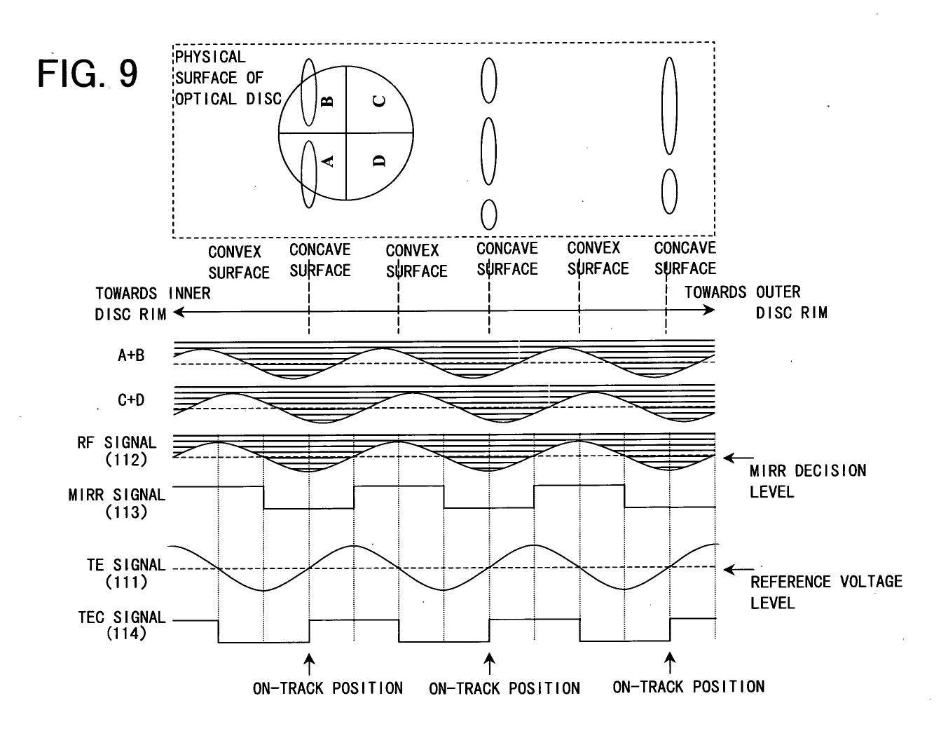

In more detail, as may be seen from FIGS. 7A and 7B, the positions (1), (2), (3), (4) and (5), as well as the position (16), are assumed by the photodetector when it is on an outer side, more precisely, on a radially outer side, of the closest track of the optical disc, that is, the track the photodetector is closest to (track A). On the other hand, the position (17) is assumed by the photodetector when it is on an inner side, more specifically, on a radially inner side, of the closest track on the optical disc, that is, the track B. At this time, the signal level of the TEC signal 24 changes from the high level to the low level, with the level of the MIRR signal 23 remaining changing, as shown in FIG. 7B. Referring also to FIG. 9, after the MIRR signal 23 is changed from an on-track state (low level) to an off-track state (high level), the photodetector is moved over the convex surface of the disc from the outer side of the current track to the inner side of the next track. This is detected as being the off-track state. In other words, no off-track state is detected as long as the photodetector is moving in an oscillating manner on the same side of a given track, while the movement of the photodetector across the convex surface of the disc from the inner side towards the outer side or vice versa is taken to be the off-track state. It is a crucial point that the photodetector is moved across (transverse of) the convex surface of the disc. No off-track state is detected as long as the photodetector is moved in an oscillating manner within the peripheries on the inner and outer sides of a given track centering at the given track, that is, as long as the photodetector is moved (back and forth) through the states S1, S2 and S5 of FIGS. 3A, 3B and 4.

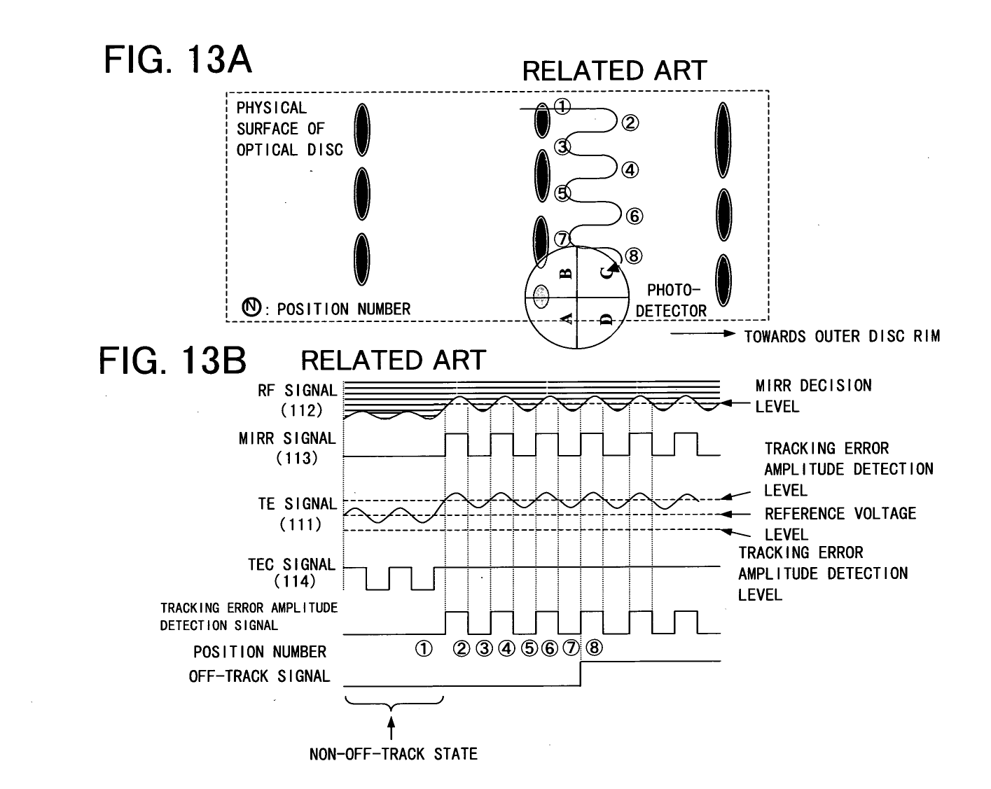

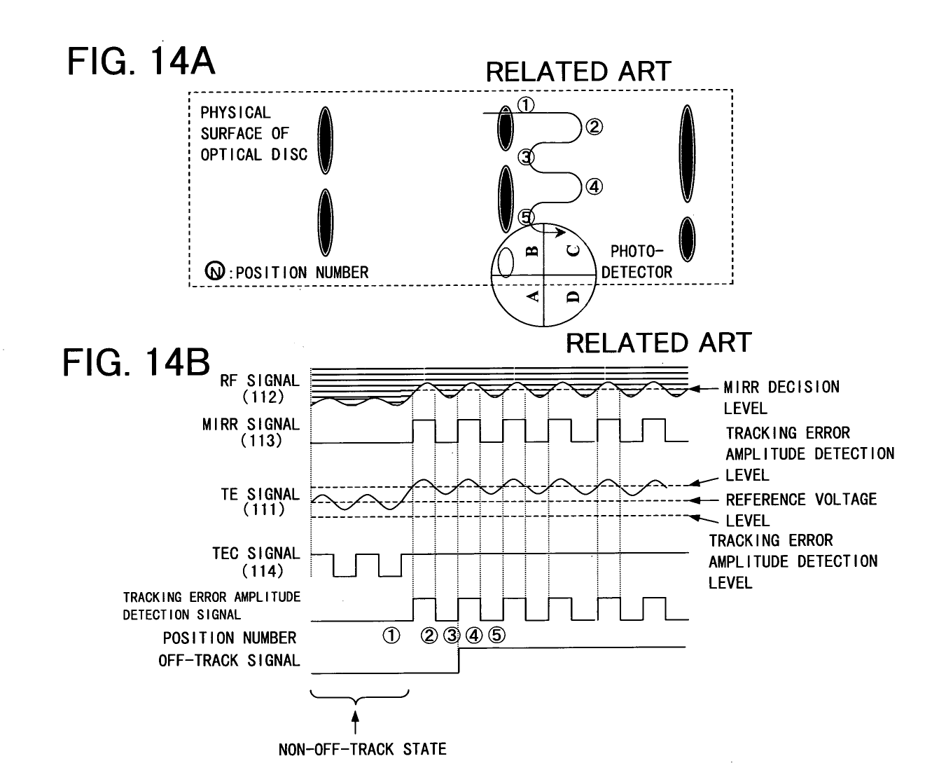

The off-track signal 25 is output in case the state S2 transitions to the state S3 or the state S5 transitions to the state S6, as shown in FIGS. 3A and 3B. Thus, the off-track signal 25 is generated as regularly, even though the MIRR signal 23 is repeatedly output in a pulsed fashion. Hence, no erroneous detection shown in FIGS. 13A and 13B or 14A and 14B occurs, so that it is possible to prevent erroneous detection of the off-track state when actually no off-track state persists, as already explained with reference to the positions (1), (2), (3), (4) and (5) shown in FIGS. 14A and 14B.

Although the present invention has so far been described with reference to preferred examples, the present invention is not to be restricted to the examples. It is to be appreciated that those skilled in the art can change or modify the examples without departing from the scope and spirit of the invention.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A tracking controlling apparatus comprising:
a photodetector that converts light reflected back from an optical disc into an electrical signal;
a MIRR signal generator that generates a MIRR signal, based on an output signal of said photodetector; said MIRR signal representing, by a bi-level signal, whether said reflected light corresponds to a concave part or a convex part in said optical disc;
a TEC signal generator that generates a TEC signal, based on an output signal of said photodetector; said TEC signal representing, by a bi-level signal, whether said photodetector is positioned on an inner side or on an outer side in a radial direction of said optical disc with respect to a track closest to said photodetector; and
an off-track detector that detects an off-track state, by detecting change in the level of said TEC signal without change in the level of said MIRR signal, in case the level of said MIRR signal indicates that said reflected light corresponds to said convex part.

2. The tracking controlling apparatus according to claim 1 wherein
said MIRR signal indicates that, when said reflected light corresponds to said concave part, said MIRR signal is in an on-track state with respect to said track of said optical disc, and that, when said reflected light corresponds to said convex part, said MIRR signal is in an off-track state with respect to said track; and wherein
said off-track detector outputs an off-track signal if the level of said MIRR signal has changed from an on-track state to an off-track state and thereafter the level of said TEC signal has changed without change in the level of said MIRR signal.

3. The tracking controlling apparatus according to claim 1 wherein
said off-track detector exercises state transition control over states comprising:
a first state in which the level of said MIRR signal indicates an on-track state;
a second state to which said first state transitions if, in said first state, said TEC signal is in a second level and the level of said MIRR signal indicates an off-track state;
a third state to which said second state transitions if, in said second state, said TEC signal has changed to a first level;
a fourth state to which said first state transitions if, in said first state, said TEC signal is in said first level and the level of said MIRR signal represents an off-track state; and
a fifth state to which said fourth state transitions if, in said fourth state, said TEC signal has changed to said second level;
said off-track detector outputting an off-track signal when state transition is to said third state or to said fifth state.

4. The tracking controlling apparatus according to claim 3 wherein
said off-track signal indicates that, upon state transition to said third state, said photodetector has shifted from the on-track position in said first state in one radial direction of said optical disc; said off-track signal indicating that, upon state transition to said fifth state, said photodetector has shifted from the on-track position in said first state in the other radial direction of said optical disc.

5. The tracking controlling apparatus according to claim 3 wherein
said off-track detector exercises state transition control so that
if, in said third state, the level of said MIRR signal indicates an on-track state, the state transitions from a state in which said photodetector is at said track in said first state to a state in which said photodetector is moved to a neighboring track along one radial direction of said optical disc;
if, in said third state, said TEC signal has changed to said second level, the state transitions to said second state;
if, in said fifth state, the level of said MIRR signal indicates an on-track state, the state transitions from a state in which said photodetector is at said track in said first state to a state in which said photodetector is moved to a neighboring track along the other radial direction of said optical disc; and
if, in said fifth state, said TEC signal has changed to said first level, the state transitions to said fourth state.

6. A tracking controlling method comprising:
providing a tracking controlling apparatus including:
a photodetector that converts light reflected back from an optical disc into an electrical signal;
a MIRR signal generator that generates a MIRR signal, based on an output signal of said photodetector; said MIRR signal representing, by a bi-level signal, whether said reflected light corresponds to a concave part or a convex part in said optical disc; and
a TEC signal generator that generates a TEC signal, based on an output signal of said photodetector; said TEC signal representing, by a bi-level signal, whether said photodetector is positioned on an inner side or on an outer side in the radial direction of said optical disc with respect to a track currently closest to said photodetector; and
determining an off-track state, where, at a level of said MIRR signal indicating that said reflected light corresponds to said convex part, a level of said TEC signal is changed, without change in the level of said MIRR signal.

7. The tracking controlling method according to claim 6 wherein said MIRR signal indicates an on-track state with respect to said track of said optical disc when said reflected light corresponds to said concave part; said MIRR signal indicating an off-track state when said reflected light corresponds to said convex part;
wherein state transition control exercises control over steps comprising:
carrying out state transition to a first state in case the level of said MIRR signal indicates an on-track state;
carrying out state transition to a second state if, in said first state, said TEC signal is in a second level, and the level of said MIRR signal indicates an off-track state;
carrying out state transition to a third state if, in said second state, said TEC signal has changed to a first level;
carrying out state transition to a fourth state if, in said first state, said TEC signal is in said first level and the level of said MIRR signal indicates an off-track state; and
carrying out state transition to a fifth state if, in said fourth state, said TEC signal has changed to said second level;
and wherein
state transition to said third state or to said fifth state is determined to be an off-track state.

8. A program run on a computer, said computer making up a tracking controlling apparatus including a photodetector for converting the light reflected back from an optical disc into an electrical signal, a MIRR signal generator for generating a MIRR signal, based on an output signal of said photodetector, said MIRR signal representing, by a bi-level signal, whether said reflected light corresponds to a concave part or a convex part in said optical disc, and a TEC signal generator for generating a TEC signal, based on an output signal of said photodetector; said TEC signal representing, by a bi-level signal, whether said photodetector is positioned on an inner side or on an outer side in the radial direction of said optical disc with respect to a track closest to said photodetector;
said program allowing said computer to perform processing comprising:
outputting an off-track signal if, in case the level of said MIRR signal indicates that said reflected light corresponds to said convex part, the level of said TEC signal is changed without change in the level of said MIRR signal.

9. The program according to claim 8 wherein said MIRR signal indicates an on-track state with respect to said track of said optical disc when said reflected light corresponds to said concave part; said MIRR signal indicating an off-track state when said reflected light corresponds to said convex part; wherein, in said processing of outputting said off-track signal, state transition control processing is carried out over states including:
a first state in which the level of said MIRR signal indicates an on-track state;
a second state to which said first state transitions if, in said first state, said TEC signal is in a second level and the level of said MIRR signal indicates an off-track state;
a third state to which said second state transitions if, in said second state, said TEC signal has changed to a first level;
a fourth state to which said first state transitions if, in said first state, said TEC signal is in said first level and the level of said MIRR signal represents an off-track state; and
a fifth state to which said fourth state transitions if, in said fourth state, said TEC signal has changed to said second level; and wherein
an off-track signal is output when state transition is to said third state or to said fifth state.
